(19) United States
(12) Patent Application Publication
(10) Pub. No.: US 2020/0227080 A1
(43) Pub. Date: Jul. 16, 2020

(54) CURING AGENT FOR MAGNETIC RECORDING MEDIUM, COMPOSITION FOR MAGNETIC RECORDING MEDIUM, MAGNETIC RECORDING MEDIUM, AND MANUFACTURING METHOD OF MAGNETIC RECORDING MEDIUM

(71) Applicant: FUJIFILM Corporation, Tokyo (JP)

(72) Inventors: Wataru KIKUCHI, Minami-ashigara-shi (JP); Masatoshi Yumoto, Minami-ashigara-shi (JP); Takashi Imai, Minami-ashigara-shi (JP)

(73) Assignee: FUJIFILM Corporation, Tokyo (JP)

(21) Appl. No.: 16/829,229

(22) Filed: Mar. 25, 2020

Related U.S. Application Data
(63) Continuation of application No. PCT/JP2018/033736, filed on Sep. 12, 2018.

(30) Foreign Application Priority Data
Sep. 26, 2017 (JP) 2017-184839

(51) Int. Cl. G11B 5/702; G11B 5/706; G11B 5/714; G11B 5/735; G11B 5/712

(52) U.S. Cl. CPC G11B 5/7022; G11B 5/70678; G11B 5/712; G11B 5/7358; G11B 5/714

(57) ABSTRACT

The curing agent for a magnetic recording medium includes a compound represented by General Formula 1. In General Formula 1, X represents a monovalent heterocyclic group or a monovalent group represented by General Formula 2, Z represents an m-valent organic group, and m represents an integer of 2 or more. In General Formula 2, R¹ represents an alkyl group, R² represents a hydrogen atom, an alkyl group, or an aryl group, and * represents a bonding site with an adjacent carbon atom.

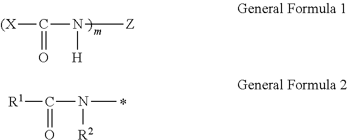

### CROSS-REFERENCE TO RELATED APPLICATIONS

This application is a Continuation of PCT International Application No. PCT/JP2018/033736 filed on Sep. 12, 2018, which claims priority under 35 U.S.C. § 119(a) to Japanese Patent Application No. 2017-184839 filed on Sep. 26, 2017. Each of the above applications is hereby expressly incorporated by reference, in its entirety, into the present application.

### BACKGROUND OF THE INVENTION

### 1. Field of the Invention

The present invention relates to a curing agent for a magnetic recording medium, a composition for a magnetic recording medium, a magnetic recording medium, and a manufacturing method of a magnetic recording medium.

### 2. Description of the Related Art

Each layer of a coating type magnetic recording medium can be formed through a step of applying a composition including a powder component (ferromagnetic powder and/or non-magnetic powder) and a binding agent on a non-magnetic support. In recent years, a curing agent is included in such a composition (for example, see JP1992-003313A (JP-H4-003313 A).

### SUMMARY OF THE INVENTION

A curing agent widely used in manufacturing of a coating type magnetic recording medium (hereinafter, simply referred to as a “magnetic recording medium”) is a compound including an isocyanate group (isocyanate compound). According to the isocyanate compound, a crosslinked structure can be formed by causing a curing reaction with respect to the isocyanate group, and accordingly, it is possible to increase hardness of each layer included in the magnetic recording medium. In a case where the hardness of the layer included in the magnetic recording medium can be increased, it is possible to increase running durability of the magnetic recording medium. Regarding such an isocyanate compound, JP1992-003313A (JP-H4-003313A) discloses a block isocyanate compound in which an isocyanate group is protected by a blocking agent.

The isocyanate group included in the isocyanate compound has comparatively high reactivity, and thus, the isocyanate group may be reacted and deactivated, unintentionally. Here, the deactivation is that the isocyanate compound loses a function of forming a crosslinked structure by the isocyanate group. For example, the isocyanate group has high reactivity with water, and may be deactivated by reacting with water. Meanwhile, it is known that adsorption water exists on a surface of particles configuring a powder component (for example, a ferromagnetic powder included in a magnetic layer, a non-magnetic powder included in a non-magnetic layer, and the like) included in each layer of the magnetic recording medium. In a case where the isocyanate group of the isocyanate compound is reacted with this adsorption water and deactivated under the coexistence of these powder components, it is difficult to form a crosslinked structure by the isocyanate group to improve running durability of the magnetic recording medium. Therefore, it is thought that, in order to prevent deactivation of the isocyanate compound, for example, the isocyanate group is protected by the blocking agent, as performed in JP1992-003313A (JP-H4-003313A). By this protection, it is possible to prevent that the isocyanate group is unintentionally reacted and deactivated.

However, in order to increase running durability of the magnetic recording medium by the block isocyanate compound, the isocyanate group should be reproduced by dissociation of the blocking agent protecting the isocyanate group from the block isocyanate compound, in order to form the crosslinked structure by the isocyanate group. Regarding the dissociation of the blocking agent, the block isocyanate compound proposed in the related art as the curing agent for a magnetic recording medium tends to have poor reactivity in the dissociation reaction. For example, in a case of using an oxime compound used in examples of JP1992-003313A (JP-H4-003313A), it is necessary to use a heat treatment at a comparatively high temperature and a catalyst, in order for the dissociation of the blocking agent. Regarding this point, the block agent can be dissociated under a milder condition (for example, heat treatment at a lower temperature), in a case where the reactivity of the blocking agent in the dissociation reaction is excellent.

In such a circumstance, an object of the invention is to provide a curing agent for a magnetic recording medium including a block isocyanate compound capable of dissociating a blocking agent under a milder condition compared to that in the related art.

One aspect of the invention relates to a curing agent for a magnetic recording medium including a compound represented by General Formula 1.

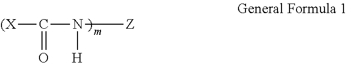

In General Formula 1, X represents a monovalent heterocyclic group or a monovalent group represented by General Formula 2, Z represents an m-valent organic group, and m represents an integer of 2 or more.

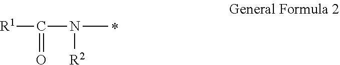

In General Formula 2, R¹ represents an alkyl group, R² represents a hydrogen atom, an alkyl group, or an aryl group, and * represents a bonding site with an adjacent carbon atom.

In the invention and the specification, the “curing agent” includes a curing agent including a compound in which a curable functional group capable of forming a crosslinked structure is generated by dissociation of the blocking agent. The compound represented by General Formula 1 can generate an isocyanate group which is a curable functional group “O═C═N—” by the dissociation of the blocking agent from a partial structure “X—C(═O)NH—” in General Formula 1.

In the invention and the specification, the “heterocyclic group” is a cyclic group in which one or more atoms configuring a cyclic structure are atoms other than carbon atoms, and the “organic group” is a group containing carbon atoms as the atom configuring this group. The details of specific examples and the like of the heterocyclic group and the organic group will be described later.

In one aspect, in General Formula 1, m may represent an integer of 2 to 8.

In one aspect, in General Formula 1, X may represent a monovalent nitrogen-containing heterocyclic group.

According to another aspect of the invention, there is provided a composition for a magnetic recording medium comprising: a ferromagnetic powder; a binding agent; and the curing agent for a magnetic recording medium.

In one aspect, the binding agent includes a binding agent including an active hydrogen-containing group. In the invention and the specification, the “active hydrogen-containing group” is a functional group capable of forming a crosslinked structure by a curing reaction between this group and a curable functional group and dissociation of hydrogen atoms included in this group, and the details of specific examples and the like will be described later.

In one aspect, the active hydrogen-containing group may be a hydroxy group, an amino group, or a mercapto group.

In one aspect, an average particle size of the ferromagnetic powder may be 10 nm to 50 nm.

In one aspect, the ferromagnetic powder may be a ferromagnetic hexagonal ferrite powder.

According to still another aspect of the invention, there is provided a magnetic recording medium comprising: a non-magnetic support; and a magnetic layer provided on the non-magnetic support, in which the magnetic layer is a cured layer obtained by curing the composition for a magnetic recording medium. Here, the “cured layer obtained by curing” the composition for a magnetic recording medium is a layer in which a crosslinked structure is formed by a curing reaction of an isocyanate group generated from the compound represented by General Formula 1.

According to still another aspect of the invention, there is provided a manufacturing method of a magnetic recording medium including a non-magnetic support, and a magnetic layer provided on the non-magnetic support, the method comprising:

forming the magnetic layer on the non-magnetic support,

in which the forming of the magnetic layer includes
applying the composition for a magnetic recording medium on the non-magnetic support to form a coating layer, and
performing a heat treatment with respect to the coating layer.

In one aspect, the heat treatment may be performed in an atmosphere with an atmosphere temperature of 50° C. to 90° C.

According to one aspect of the invention, it is possible to provide a curing agent for a magnetic recording medium including a block isocyanate compound capable of dissociating a blocking agent under milder condition compared to that in the related art.

### DESCRIPTION OF THE PREFERRED EMBODIMENTS

In the invention and the specification, the disclosed group may have a substituent or may not have a substituent, unless otherwise noted. In a case where a given group has a substituent, the examples of the substituent include an alkyl group (for example, an alkyl group having 1 to 6 carbon atoms), a hydroxy group, an alkoxy group (for example, an alkoxy group having 1 to 6 carbon atoms), an halogen atom (for example, a fluorine atom, a chlorine atom, a bromine atom, and the like), a cyano group, an amino group, a nitro group, an acyl group, a carboxy group, salt of a carboxy group, a sulfonic acid group, and salt of a sulfonic acid group. In addition, the “number of carbons” regarding the group having a substituent means the number of carbons including the number of carbons of the substituent, unless otherwise noted.

In the invention and the specification, the ferromagnetic powder means an aggregate of a plurality of ferromagnetic particles. The aggregate not only includes an aspect in which particles configuring the aggregate are directly in contact with each other, but also includes an aspect in which a binding agent or an additive is interposed between the particles. The same applies to the other powders such as non-magnetic powder.

### Curing Agent for Magnetic Recording Medium

One aspect of the invention relates to a curing agent for a magnetic recording medium including a compound represented by General Formula 1. General Formula 1 is shown below. The curing agent for a magnetic recording medium can be only one kind of a compound represented by General Formula 1, and can also be a mixture including two or more kinds of compounds represented by General Formula 1 having different structures derived from the same synthesis raw material. Hereinafter, General Formula 1 will be described.

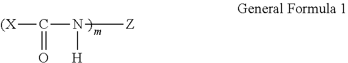

In General Formula 1, X represents a monovalent heterocyclic group or a monovalent group represented by General Formula 2.

As the monovalent heterocyclic group (hereinafter, also simply referred to as the “heterocyclic group”), a heterocyclic group including one or more atoms other than carbon atoms such as a nitrogen atom, an oxygen atom, or a sulfur atom, as a hetero atom configuring a cyclic structure can be used, and a nitrogen-containing heterocyclic group including at least one or more nitrogen atoms as a hetero atom configuring a cyclic structure is preferable. In addition, the heterocyclic ring included in the heterocyclic group may be a single ring, a fused ring, an aromatic ring, or a non-aromatic ring. As the heterocyclic group, a heterocyclic group having a 5- to 10-membered ring is preferable, and a heterocyclic group having a 5- to 7-membered ring is more preferable. Specific examples of the monovalent heterocyclic group include a substituted or unsubstituted imidazolyl group, a substituted or unsubstituted pyrazolyl group, a substituted or unsubstituted triazolyl group, a substituted or unsubstituted benzimidazolyl group, a substituted or unsubstituted pyridyl group, a substituted or unsubstituted pyrimidino group, and a substituted or unsubstituted quinolino group, a substituted or unsubstituted imidazolyl group, a substituted or unsubstituted pyrazolyl group, a substituted or unsubstituted benzimidazolyl group, and a substituted or unsubstituted triazolyl group, are preferable, a substituted or unsubstituted imidazolyl group and a substituted or unsubstituted pyrazolyl group are more preferable, from a viewpoint of reactivity of the blocking agent in the dissociation reaction, and a substituted or unsubstituted pyrazolyl group is even more preferable.

Various heterocyclic groups such as heterocyclic groups of the specific examples described above may have a substituent or may be non-substitutional. Regarding the heterocyclic group having a substituent, a substitution position of the substituent is not particularly limited. As the substituent, the substituents described above can be used, an alkyl group is preferable, an alkyl group having 1 to 6 carbon atoms is more preferable, and an alkyl group having 1 to 3 carbon atoms is even more preferable.

In General Formula 1, in one aspect, X can be a monovalent group represented by General Formula 2. General Formula 2 is as follows.

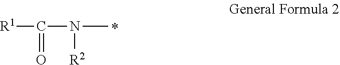

In General Formula 2, R¹ represents an alkyl group. In the invention and the specification, the “alkyl group” includes a linear alkyl group, a branched alkyl group, and a cycloalkyl group, and includes a substituted alkyl group and an unsubstituted alkyl group. In the substituted alkyl group, the substituents described above are used, as the substituent.

The alkyl group represented by R¹ can be any alkyl group of a linear alkyl group, a branched alkyl group, and a cycloalkyl group, a linear alkyl group or a branched alkyl group is preferable, and a linear alkyl group is more preferable. In addition, the alkyl group represented by R¹ can be a substituted alkyl group or an unsubstituted alkyl group, and an unsubstituted alkyl group is preferable. The number of carbons of the alkyl group represented by R¹ is preferably 1 to 20, more preferably 1 to 18, even more preferably 1 to 13, still preferably 1 to 6, and still more preferably 1 to 3.

In General Formula 2, R² represents a hydrogen atom, an alkyl group, or an aryl group.

The alkyl group represented by R² can be any alkyl group of a linear alkyl group, a branched alkyl group, and a cycloalkyl group, a linear alkyl group or a branched alkyl group is preferable, and a linear alkyl group is more preferable. In addition, the alkyl group represented by R² can be a substituted alkyl group or an unsubstituted alkyl group, and an unsubstituted alkyl group is preferable. The number of carbons of the alkyl group represented by R² is preferably 1 to 10, more preferably 1 to 6, even more preferably 1 to 3. The alkyl group represented by R² is even more preferably a methyl group.

The aryl group represented by R² can be a substituted or unsubstituted aryl group, and an unsubstituted aryl group is preferable. The aryl group is a monovalent aromatic carbocyclic group, a cyclic structure of the aryl group may be a single ring or a fused ring. The aryl group represented by R² is preferably 5- to 20-membered aryl group, more preferably a phenyl group or a naphthyl group, and even more preferably a phenyl group.

In General Formula 2, * represents a bonding site with an adjacent carbon atom. As the adjacent carbon atom, a carbon atom in a carbonyl group (—C(═O)—) bonded to X in General Formula 1.

In General Formula 1, m represents an integer of 2 or more. Accordingly, the compound represented by General Formula 1 has a plurality of (m) partial structures (X—C(═O)NH—) linked to Z. In one aspect, the plurality of partial structures can have the same structure, and in another aspect, the plurality of partial structures can have structures different from each other. From a viewpoint of ease of synthesis of the compound represented by General Formula 1, the plurality of partial structures preferably have the same structure.

The compound in General Formula 1, in which m is 1, can generate a monofunctional isocyanate compound having one isocyanate group in one molecule, by dissociation of the blocking agent. Meanwhile, the compound in General Formula 1, in which m is an integer of 2 or more, can generate a polyfunctional isocyanate compound having two or more isocyanate groups in one molecule, by dissociation of the blocking agent. From a viewpoint of further improving running durability of the magnetic recording medium, it is preferable to use the polyfunctional isocyanate compound, and therefore, m preferably represents an integer of 2 or more. m, for example, can be an integer of 2 to 8, is preferably an integer of 2 to 6, more preferably an integer of 2 to 4, and even more preferably an integer of 2 or 3.

In General Formula 1, Z represents an m-valent organic group (hereinafter, also simply referred to as an “organic group”). The organic group represented by Z can represent an organic group configured with one or a combination of two or more divalent groups selected from the group consisting of —C(═O)—O—, —O—, —C(═O)—NR— (R represents a hydrogen atom or an alkyl group having 1 to 4 carbon atoms), an arylene group (for example, phenylene group), and a substituted or unsubstituted alkylene group having 1 to 30 carbon atoms (also including cycloalkylene group). Z can also has a cyclic structure in the structure configured with the combination of two or more groups selected from the groups described above. In one aspect, the organic group represented by Z can include one or more divalent groups represented by “—NH—C(═O)—O—”, preferably includes two or more (for example, 2 to 4) divalent groups, and more preferably includes 3 or more divalent groups. In addition, in one aspect, the organic group represented by Z can include one or more arylene groups, preferably includes two or more (for example, 2 to 4) arylene groups, and more preferably 3 or more arylene groups. The arylene group is preferably an arylene group having a 5- to 20-membered ring, more preferably an arylene group having a 5- to 12-membered ring, and even more preferably a phenylene group. In addition, the arylene group can be a substituted or unsubstituted arylene group. As the substituted arylene group, an alkyl-substituted arylene group is preferable, and an alkyl-substituted arylene group in which an alkyl group having 1 to 3 carbon atoms is substituted is more preferable. In addition, in one aspect, the organic group represented by Z can include one or more cycloalkylene groups, preferably includes two or more (for example, 2 to 4) cycloalkylene groups, and more preferably includes three or more cycloalkylene groups. The cycloalkylene group is preferably a cycloalkylene group having a 5- to 20-membered ring, more preferably a cycloalkylene group having a 5- to 12-membered ring, and even more preferably a cyclohexylene group. In addition, the cycloalkylene can be a substituted or unsubstituted cycloalkylene group. As the substituted cycloalkylene group, an alkyl-substituted cycloalkylene group is preferable, and an alkyl-substituted cycloalkylene group in which an alkyl group having 1 to 3 carbon atoms is substituted is more preferable.

In addition, from a viewpoint of reactivity of isocyanate group generated due to the dissociation of the blocking agent in the curing reaction, in the organic group represented by Z, the arylene group or the cycloalkylene group included in this organic group is preferably directly bonded to an adjacent nitrogen atom or bonded to an adjacent nitrogen atom through an alkylene group (except the cycloalkylene group), and the arylene group is more preferably directly bonded to the adjacent nitrogen atom.

Specific examples of the organic group represented by Z include the following organic groups. In the structure of the organic group below, * represents a bonding site to the adjacent nitrogen atom. The adjacent nitrogen atom is a nitrogen atom included in a partial structure “X—C(═O)NH—” in General Formula 1. Hereinafter, n represents an integer of 1 or more, and, for example, represents an integer of 1 to 6.

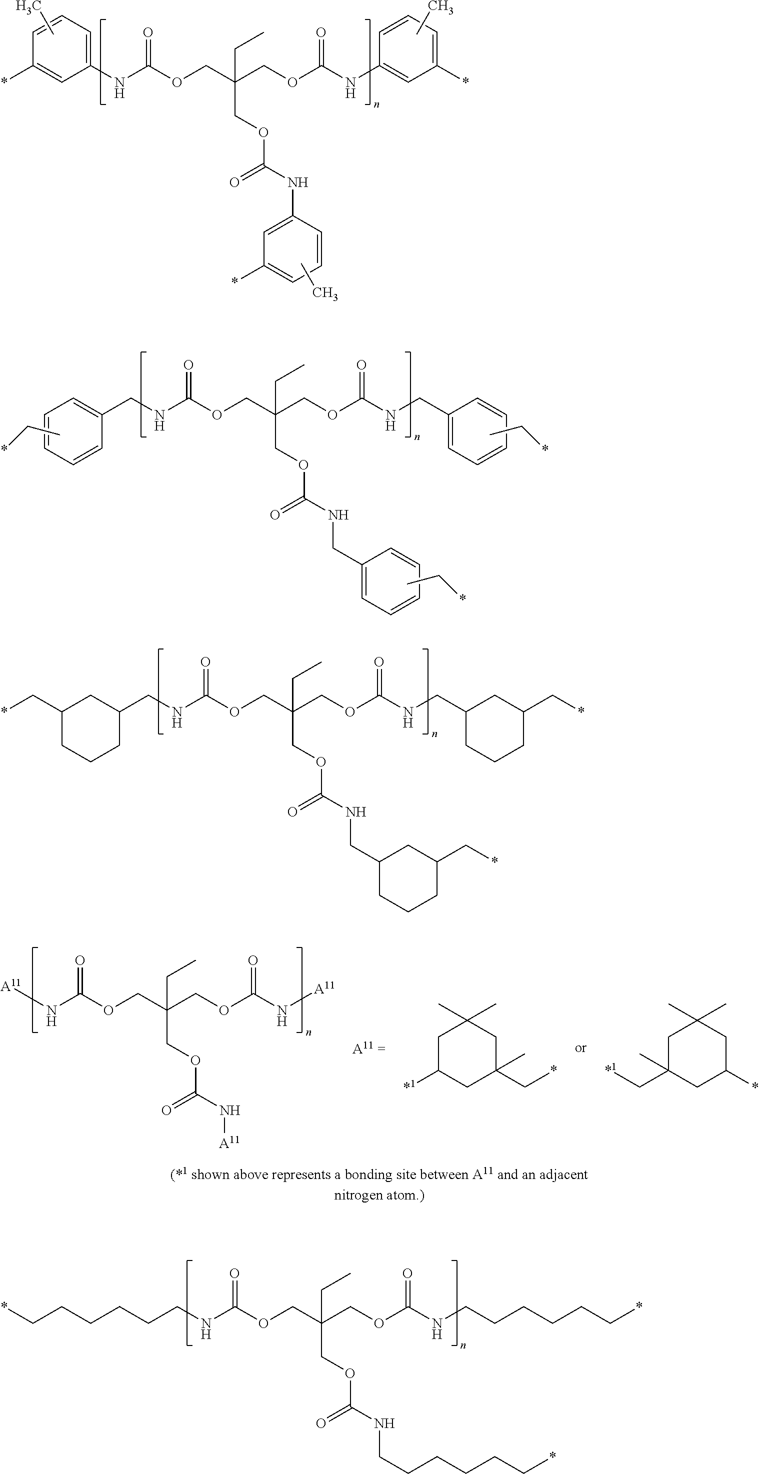

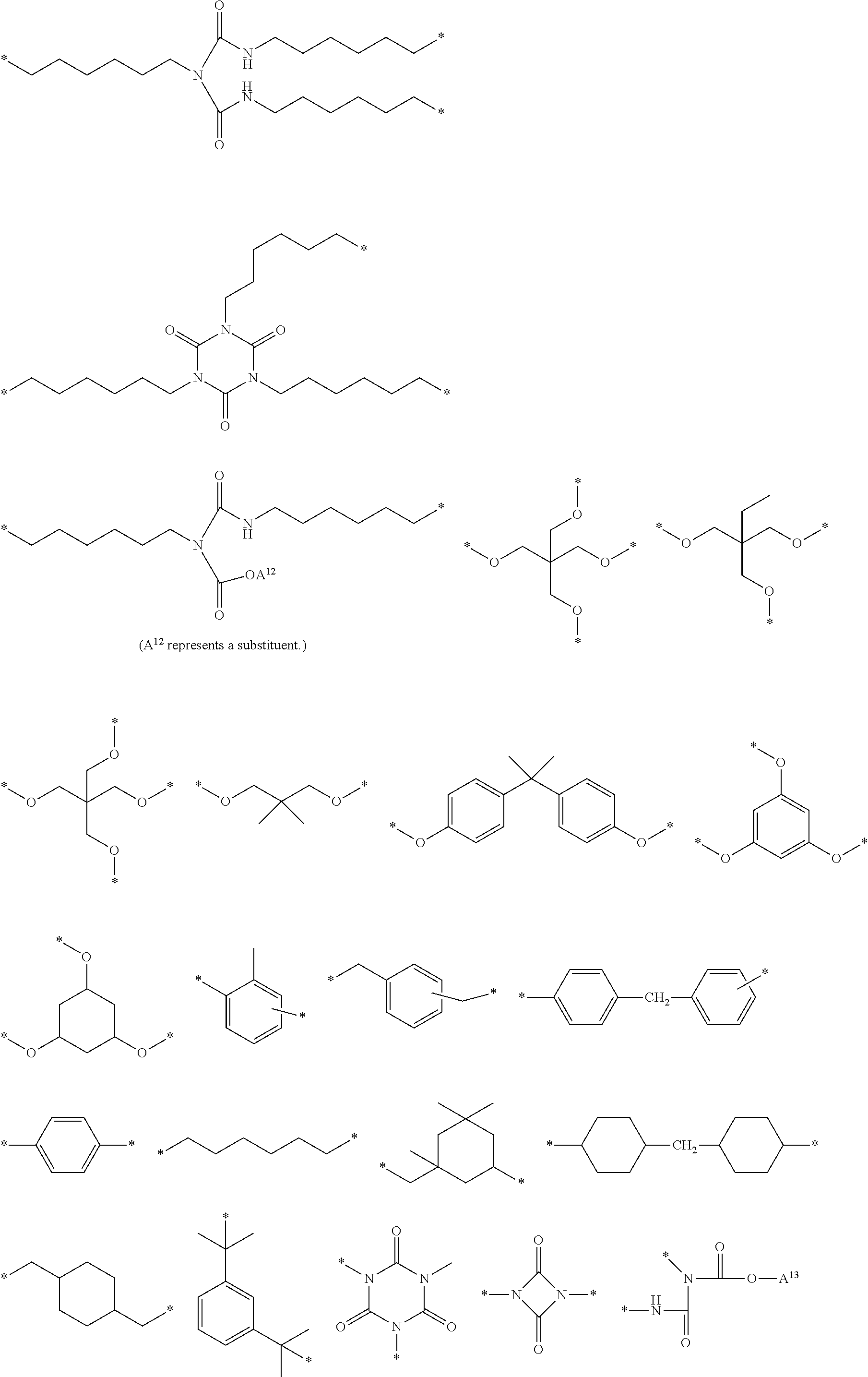

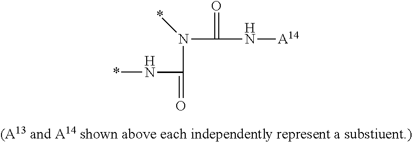

In General Formula 1, m represents an integer of 2 or more, and accordingly, the organic group represented by Z has two or more bonding sites to the adjacent nitrogen atom. For example, the organic group described above has two or more * representing the bonding site to the adjacent nitrogen atom.

The compound represented by General Formula 1 in which Z represents a divalent organic group, may be obtained as a mixture with a byproduct in which one bonding site to the adjacent nitrogen atom in Z of General Formula 1 represents a bonding site to an adduct generated by hydrolysis of the isocyanate group. A schematic description of a scheme of a reaction to generate the adduct is shown below. Hereinafter, a vertical wavy line is used for showing that the structure shown below is a part of the compound. In addition, hereinafter, R represents a substituent, and the compound represented by R—NCO is, for example, a reaction product generated by protecting the isocyanate compound or a part of the isocyanate group included in the isocyanate compound used in the synthesis of the compound represented by General Formula 1 is protected by the blocking agent. Such a byproduct can also be generated regarding the compound represented by General Formula 1 in which Z represents a trivalent organic group.

In addition, as a specific example of the organic group represented by Z, among the structures of the specific examples of Z described above, including three or more *, a structure in which at least two * represent bonding sites to the adjacent nitrogen atom, and the remaining * represents a bonding site to the adduct generated by hydrolysis of the isocyanate group can be used. The compound represented by General Formula 1 in which Z represents a three- or higher valent organic group may be obtained as a mixture of compounds having different numbers of bonding sites to the adjacent nitrogen atom (that is, valence m is different), generated as described above.

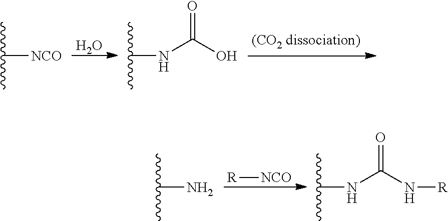

### Molecular Weight

The compound represented by General Formula 1 is preferably a compound having a lower molecular weight than that of a resin generally used as a binding agent of a magnetic recording medium, from a viewpoint of further improving running durability of the magnetic recording medium. This is because the compound having a lower molecular weight can contribute to an increase in crosslinking density. The compound represented by General Formula 1 may be used as the curing agent for a magnetic recording medium, by being isolated from a compound having a single structure, or may be used as a mixture of two or more kinds of compounds having different structures derived from the same synthesis raw material. In the invention and the specification, the molecular weight of the compound represented by General Formula 1 is disclosed as a weight-average molecular weight as a molecular weight of an aspect used as the curing agent for a magnetic recording medium. In the invention and the specification, the “weight-average molecular weight” is a weight-average molecular weight obtained by performing standard polystyrene conversion of a value measured by gel permeation chromatography (GPC). The weight-average molecular weight of the compound represented by General Formula 1 is preferably 500 to 10,000, more preferably 500 to 7,000, even more preferably 500 to 5,000, still preferably 500 to 3,000, and still more preferably 500 to 2,000. As measurement conditions of the GPC, the following conditions can be used. The weight-average molecular weight shown in the examples which will be described later is a value measured by the measurement conditions shown below.

GPC device: HLC-8220 (manufactured by Tosoh Corporation)

Guard Column: TSK guard column Super HZM-H

Column: TSK gel Super HZ 2000, TSK gel Super HZ 4000, TSK gel Super HZ-M (manufactured by Tosoh Corporation, 4.6 mm (inner diameter)×15.0 cm, three kinds of columns are linked in series)

Eluent: Tetrahydrofuran (THF), including stabilizer (2,6-di-t-butyl-4-methylphenol)

Eluent flow rate: 0.35 mL/min

Column temperature: 40° C.

Inlet temperature: 40° C.

Refractive index (RI) measurement temperature: 40° C.

Sample concentration: 0.3% by mass

Sample injection amount: 10 μL

### Synthesis Method

The compound represented by General Formula 1 can be obtained by protecting the isocyanate group included in the isocyanate compound by causing the isocyanate compound to react with the blocking agent. The structure in which the isocyanate group is protected by the blocking agent is a partial structure “X—C(═O)NH—” in General Formula 1. The isocyanate compound used as a synthesis raw material can be purchased as a commercially available product or can also be synthesized by a well-known method. The same applies to the blocking agent. The organic group represented by Z in General Formula 1 is derived by the isocyanate compound used as the synthesis raw material, and X in General Formula 1 is derived by the blocking agent. Regarding the reaction between the isocyanate compound and the blocking agent, a well-known can be used. For example, the reaction between the isocyanate compound and the blocking agent can be performed by adding the isocyanate compound and the blocking agent to a reaction solvent to prepare a reaction solution, and stirring this reaction solution, after heating. The reaction is preferably performed, for example, in an inert atmosphere such as a nitrogen atmosphere. The reaction conditions such as a kind of the reaction solvent, a heating temperature, a reaction time, and the like are not particularly limited, and may be set in accordance with the kind of the isocyanate compound and the blocking agent used. The structure of the reaction product can be identified by a well-known method. For example, the structure of the reaction product can be identified from the used amount of the synthesis raw material and the weight-average molecular weight obtained regarding the reaction product. In addition, in a case where a peak of the isocyanate group is eliminated by analyzing the reaction solution by infrared spectroscopy (IR), it is possible to find that a compound in which all isocyanate groups of the isocyanate compound used as the synthesis raw material are protected by the blocking agent is obtained.

The curing agent for a magnetic recording medium described above can be used as a component of a composition for a magnetic recording medium. Such a composition for a magnetic recording medium can be preferably a thermosetting composition, and is preferably used for forming a cured layer by proceeding the curing reaction by the heat treatment. Hereinafter, the composition for a magnetic recording medium which can be used for forming a magnetic layer of the magnetic recording medium will be described. However, the curing agent for a magnetic recording medium can also be used as a component of a composition for a magnetic recording medium including a non-magnetic powder and a binding agent, in order to form a non-magnetic layer provided between a non-magnetic support and a magnetic layer. In addition, the curing agent for a magnetic recording medium can also be used as a component of a composition for a magnetic recording medium including a non-magnetic powder and a binding agent, in order to form a back coating layer provided on a surface of a non-magnetic support on a side opposite to a surface provided with a magnetic layer.

### Composition for Magnetic Recording Medium

The composition for a magnetic recording medium according to one aspect of the invention is a composition for a magnetic recording medium including a ferromagnetic powder, a binding agent, and the curing agent for a magnetic recording medium. The composition for a magnetic recording medium (hereinafter, also simply referred to as a “composition”) is a composition including the ferromagnetic powder, and accordingly, the composition can be used for forming a magnetic layer of the magnetic recording medium.

A content of the curing agent for a magnetic recording medium included in the composition is preferably equal to or greater than 1.0 part by mass and more preferably equal to or greater than 2.0 parts by mass, with respect to 100.0 parts by mass of the ferromagnetic powder, from a viewpoint of improving hardness of the magnetic layer formed using this composition. In addition, the content (referred to as a filling percentage) of the ferromagnetic powder in the magnetic layer is preferably high, from a viewpoint of improving a recording density. Therefore, a content of a component other than the ferromagnetic powder in the magnetic layer is preferably low, from a viewpoint of improving a recording density. From this viewpoint, the content of the curing agent for a magnetic recording medium included in the composition is preferably equal to or smaller than 8.0 parts by mass and more preferably equal to or smaller than 5.0 parts by mass, with respect to 100 parts by mass of the ferromagnetic powder. The composition may be a so-called one-agent type composition and may be a multi-agent type composition which is two or more-agent types. For example, the composition also includes an aspect in which a composition including a ferromagnetic powder and a binding agent (first agent) and the curing agent for a magnetic recording medium or a composition including this curing agent (second agent) are mixed with each other, before being used for forming a magnetic layer. Regarding the multi-agent type composition, the contents of various components described above and below are contents in a case where all components configuring the composition are mixed with each other.

Hereinafter, various components included (or which can be included) in the composition for a magnetic recording medium will be described.

### Ferromagnetic Powder

The ferromagnetic powder preferably has an average particle size equal to or smaller than 50 nm. This is because that the ferromagnetic powder having an average particle size equal to or smaller than 50 nm is a ferromagnetic powder which can respond to high-density recording required recently. However, as the average particle size of the ferromagnetic powder is small, a specific surface area of particles configuring the ferromagnetic powder increases, and accordingly, the amount of adsorption water tends to increase and a water content of the ferromagnetic powder tends to increase. As described above, the adsorption water of the ferromagnetic powder can be a reason of the deactivation of the isocyanate compound, and accordingly, it is thought that, as the average particle size of the ferromagnetic powder decreases, the isocyanate compound tends to be easily deactivated. In contrast, the isocyanate group is protected by the blocking agent, and accordingly, even in a case where the curing agent for a magnetic recording medium is included in the composition together with the ferromagnetic powder having a small average particle size, it is possible to prevent a reaction between the isocyanate group and the adsorption water of the ferromagnetic powder. The average particle size of the ferromagnetic powder is preferably equal to or greater than 10 nm and more preferably equal to or greater than 20 nm, from a viewpoint of stability of magnetization.

In the invention and the specification, average particle sizes of various powder such as the ferromagnetic powder and the like are values measured by the following method with a transmission electron microscope, unless otherwise noted.

The powder is imaged at a magnification ratio of 100,000 with a transmission electron microscope, the image is printed on photographic printing paper so that the total magnification of 500,000 to obtain an image of particles configuring the powder. A target particle is selected from the obtained image of particles, an outline of the particle is traced with a digitizer, and a size of the particle (primary particle) is measured. The primary particle is an independent particle which is not aggregated.

The measurement described above is performed regarding 500 particles randomly extracted. An arithmetical mean of the particle size of 500 particles obtained as described above is an average particle size of the powder. As the transmission electron microscope, a transmission electron microscope H-9000 manufactured by Hitachi, Ltd. can be used, for example. In addition, the measurement of the particle size can be performed by well-known image analysis software, for example, image analysis software KS-400 manufactured by Carl Zeiss. The average particle size shown in examples which will be described later is a value measured by using transmission electron microscope H-9000 manufactured by Hitachi, Ltd. as the transmission electron microscope, and image analysis software KS-400 manufactured by Carl Zeiss as the image analysis software.

As a method of collecting a sample powder from the magnetic recording medium in order to measure the particle size, a method disclosed in a paragraph of 0015 of JP2011-048878A can be used, for example.

In the invention and the specification, unless otherwise noted, (1) in a case where the shape of the particle observed in the particle image described above is a needle shape, a fusiform shape, or a columnar shape (here, a height is greater than a maximum long diameter of a bottom surface), the size (particle size) of the particles configuring the powder is shown as a length of a long axis configuring the particle, that is, a long axis length, (2) in a case where the shape of the particle is a planar shape or a columnar shape (here, a thickness or a height is smaller than a maximum long diameter of a plate surface or a bottom surface), the particle size is shown as a maximum long diameter of the plate surface or the bottom surface, and (3) in a case where the shape of the particle is a sphere shape, a polyhedron shape, or an unspecified shape, and the long axis configuring the particles cannot be specified from the shape, the particle size is shown as an equivalent circle diameter. The equivalent circle diameter is a value obtained by a circle projection method.

In addition, regarding an average acicular ratio of the powder, a length of a short axis, that is, a short axis length of the particles is measured in the measurement described above, a value of (long axis length/short axis length) of each particle is obtained, and an arithmetical mean of the values obtained regarding 500 particles is calculated. Here, unless otherwise noted, in a case of (1), the short axis length as the definition of the particle size is a length of a short axis configuring the particle, in a case of (2), the short axis length is a thickness or a height, and in a case of (3), the long axis and the short axis are not distinguished, thus, the value of (long axis length/short axis length) is assumed as 1, for convenience.

In addition, unless otherwise noted, in a case where the shape of the particle is specified, for example, in a case of definition of the particle size (1), the average particle size is an average long axis length, in a case of the definition (2), the average particle size is an average plate diameter. In a case of the definition (3), the average particle size is an average diameter (also referred to as an average particle diameter).

As a preferred specific example of the ferromagnetic powder, a ferromagnetic hexagonal ferrite powder can be used. For details of the ferromagnetic hexagonal ferrite powder, for example, a description disclosed in paragraphs 0134 to 0136 of JP2011-216149A can be referred to.

As the preferred specific example of the ferromagnetic powder, a ferromagnetic metal powder can also be used. For details of the ferromagnetic metal powder, for example, a description disclosed in paragraphs 0137 to 0141 of JP2011-216149A can be referred to.

A content (filling percentage) of the ferromagnetic powder of the magnetic layer is preferably 50% to 90% by mass and more preferably 60% to 90% by mass. A high filling percentage is preferable from a viewpoint of improving recording density.

### Binding Agent

The binding agent is one or more kinds of resin. As the binding agent, various resins normally used as a binding agent of the magnetic recording medium can be used. For example, as the binding agent, a resin selected from a polyurethane resin, a polyester resin, a polyamide resin, a vinyl chloride resin, an acrylic resin obtained by copolymerizing styrene, acrylonitrile, or methyl methacrylate, a cellulose resin such as nitrocellulose, an epoxy resin, a phenoxy resin, and a polyvinylalkylal resin such as polyvinyl acetal or polyvinyl butyral can be used alone or a plurality of resins can be mixed with each other to be used. Among these, a polyurethane resin, an acrylic resin, a cellulose resin, and a vinyl chloride resin are preferable. These resins may be homopolymers or copolymers. These resins can be used as the binding agent even in the non-magnetic layer and/or a back coating layer which will be described later.

In a case of forming a magnetic layer using the composition described above, the isocyanate group is generated, in a case where the blocking agent is dissociated from the compound represented by General Formula 1. Accordingly, the composition preferably includes a component having a functional group (functional group capable of forming a crosslinked structure) capable of being subjected to a curing reaction with this isocyanate group. This is because by including such a component, it is possible to increase hardness of the magnetic layer by forming a crosslinked structure. As the functional group capable of being subjected to a curing reaction with the isocyanate group, an active hydrogen-containing group can be used. Examples of the active hydrogen-containing group include a hydroxy group, an amino group (preferably, a primary amino group or a secondary amino group), a mercapto group, and a carboxy group, and a hydroxy group, an amino group and a mercapto group are preferable, and a hydroxy group is more preferable. In one aspect, as one or more kinds of the resin used as the binding agent, a resin including the active hydrogen-containing group is preferably used. In the resin including the active hydrogen-containing group, a concentration of the active hydrogen-containing group is preferably 0.10 meq/g to 2.00 meq/g. eq indicates equivalent and a unit not convertible into SI unit. In addition, the concentration of the active hydrogen-containing group can also be displayed with a unit “mgKOH/g”. In one aspect, in the resin including the active hydrogen-containing group, the concentration of the active hydrogen-containing group is preferably 1 to 20 mgKOH/g.

For the binding agent described above, for example, description disclosed in paragraphs 0028 to 0031 of JP2010-024113A can be referred to. An average molecular weight of the resin used as the binding agent can be, for example, 10,000 to 200,000, and is preferably 20,000 to 200,000, as a weight-average molecular weight. The content of the binding agent in the composition can be, for example, 5.0 to 50.0 parts by mass and is preferably 10.0 to 30.0 parts by mass, with respect to 100.0 parts by mass of the ferromagnetic powder. In the invention and the specification, a given component may be used alone or in combination of two or more kinds thereof, unless otherwise noted. In a case where two or more kinds are used, in the invention and the specification, the content regarding a given component is a total content of the two or more kinds.

### Other Components

The magnetic layer can include an additive, if necessary. Accordingly, the composition can include one or more kinds of additive. Examples of the additives include an abrasive, a lubricant, a projection formation agent, a dispersing agent, a dispersing assistant, an antibacterial agent, an antistatic agent, an antioxidant, and carbon black. As the additives, a commercially available product can be suitably selected according to the desired properties or manufactured by a well-known method, and can be used with any amount. For example, for the abrasive, a description disclosed in paragraph 0069 of JP2012-133837A can be referred to. For the lubricant, a description disclosed in paragraphs 0030 to 0033, 0035, and 0036 of JP2016-126817A can be referred to. The lubricant may be included in the composition (non-magnetic layer forming composition) used for forming a non-magnetic layer. For the lubricant included in the non-magnetic layer forming composition, a description disclosed in paragraphs 0030, 0031, 0034, 0035, and 0036 of JP2016-126817A can be referred to. In addition, for the projection formation agent, a description disclosed in paragraph 0055 of JP2016-126817A can be referred to. For the dispersing agent, a description disclosed in paragraphs 0061 and 0071 of JP2012-133837A can be referred to. The dispersing agent may be included in the non-magnetic layer forming composition. For the dispersing agent included in the non-magnetic layer forming composition, a description disclosed in paragraph 0061 of JP2012-133837A can be referred to. For the carbon black, a description disclosed in paragraph 0072 of JP2012-133837A can be referred to.

In addition, as one example of the additive, a compound containing a polyalkyleneimine chain and a polyester chain disclosed in JP2015-028830A can be used. For this compound, a description disclosed in paragraphs 0025 to 0071 and examples of JP2015-028830A can be referred to. In addition, in one aspect, one or more kinds of the additive can include the active hydrogen-containing group.

In addition, the composition can include a solvent. As the solvent, one kind or two or more kinds of solvent can be mixed and used at a random ratio. For the solvent, for example, a description disclosed in paragraphs 0093 and 0094 of JP2015-028830A can be referred to. A content of the solvent in the composition can be, for example, 100.0 to 1,500.0 parts by mass and is preferably 200.0 to 1,000.0 parts by mass, with respect to 100.0 parts by mass of the ferromagnetic powder.

The composition can be prepared by mixing various components at the same time or in any order.

### Magnetic Recording Medium and Manufacturing Method of Magnetic Recording Medium

Another aspect of the invention relates to a manufacturing method of a magnetic recording medium including a non-magnetic support, and a magnetic layer provided on the non-magnetic support, in which the magnetic layer is a cured layer obtained by curing the composition for a magnetic recording medium, the method including:

forming the magnetic layer on the non-magnetic support,

in which the forming of the magnetic layer includes
applying the composition for a magnetic recording medium on the non-magnetic support to form a coating layer, and
performing a heat treatment with respect to the coating layer.

Hereinafter, the magnetic recording medium and the manufacturing method of the magnetic recording medium will be described in detail.

### Magnetic Layer

The magnetic layer can be formed by applying the composition for a magnetic recording medium directly on a surface of the non-magnetic support, or on a surface of another layer such as a non-magnetic layer provided on the non-magnetic support, and drying to form a coating layer, and performing a process such as a heat treatment to this coating layer. By performing the heat treatment to this coating layer, the isocyanate group can be generated by dissociating the blocking agent in the compound represented by General Formula 1, and the curing reaction (formation of the crosslinked structure) of this isocyanate group can proceed. The heat treatment will be described in detail. In addition, the composition used for forming various components included in the magnetic layer and the magnetic layer is as described above.

### Non-Magnetic Layer

Next, the non-magnetic layer will be described.

The magnetic recording medium can also include a magnetic layer directly on a non-magnetic support, and can also include a non-magnetic layer including a non-magnetic powder and a binding agent between the non-magnetic support and the magnetic layer. The non-magnetic powder included in the non-magnetic layer may be inorganic powder or organic powder. In addition, carbon black and the like can be used. Examples of the inorganic powder include powder of metal, metal oxide, metal carbonate, metal sulfate, metal nitride, metal carbide, and metal sulfide. These non-magnetic powder can be purchased as a commercially available product or can be manufactured by a well-known method. For details thereof, descriptions disclosed in paragraphs 0146 to 0150 of JP2011-216149A can be referred to. For carbon black which can be used in the non-magnetic layer, descriptions disclosed in paragraphs 0040 and 0041 of JP2010-024113A can be referred to. The content (filling percentage) of the non-magnetic powder of the non-magnetic layer is preferably 50% to 90% by mass and more preferably 60% to 90% by mass.

In regards to other details of a binding agent or additives of the non-magnetic layer, the well-known technology regarding the non-magnetic layer can be applied. In addition, in regards to the type and the content of the binding agent, and the type and the content of the additive, for example, the well-known technology regarding the magnetic layer can be applied. In one aspect, the non-magnetic layer can be formed by using the curing agent for a magnetic recording medium. Regarding the composition used for forming the non-magnetic layer in this case, the description regarding the composition for a magnetic recording medium can be used by replacing a part describing the ferromagnetic powder in the above description with the non-magnetic layer. The same applies to a back coating layer which will be described later. In another aspect, the non-magnetic layer and/or the back coating layer can also be formed by using a well-known curing agent.

In the invention and the specification, the non-magnetic layer also includes a substantially non-magnetic layer including a small amount of ferromagnetic powder as impurities or intentionally, together with the non-magnetic powder. Here, the substantially non-magnetic layer is a layer having a residual magnetic flux density equal to or smaller than 10 mT, a layer having coercivity equal to or smaller than 7.96 kA/m(100 Oe), or a layer having a residual magnetic flux density equal to or smaller than 10 mT and coercivity equal to or smaller than 7.96 kA/m(100 Oe). It is preferable that the non-magnetic layer does not have a residual magnetic flux density and coercivity.

### Non-Magnetic Support

Next, the non-magnetic support (hereinafter, also simply referred to as a “support”) will be described. As the non-magnetic support, well-known components such as polyethylene terephthalate, polyethylene naphthalate, polyamide, polyamide imide, aromatic polyamide subjected to biaxial stretching are used. Among these, polyethylene terephthalate, polyethylene naphthalate, and polyamide are preferable. Corona discharge, plasma treatment, easy-bonding treatment, or heat treatment may be performed with respect to these supports in advance.

### Back Coating Layer

The magnetic recording medium can also include a back coating layer including non-magnetic powder and a binding agent on a surface side of the non-magnetic support opposite to the surface side provided with the magnetic layer. The back coating layer preferably includes any one or both of carbon black and inorganic powder. For the back coating layer, a well-known technology regarding the back coating layer can be used. For example, for the back coating layer, descriptions disclosed in paragraphs 0018 to 0020 of JP2006-331625A and page 4, line 65, to page 5, line 38, of U.S. Pat. No. 7,029,774 can be referred to. In addition, for the binding agent included in the back coating layer and various additives which can be randomly included, a well-known technology regarding the treatment of the magnetic layer and/or the non-magnetic layer can also be used.

### Various Thicknesses

A thickness of the non-magnetic support is preferably 3.0 to 20.0 μm, more preferably 3.0 to 10.0 μM, and even more preferably 3.0 to 6.0 μm.

A thickness of the magnetic layer can be optimized according to a saturation magnetization amount of a magnetic head used, a head gap length, a recording signal band, and the like. The thickness of the magnetic layer is preferably 10 nm to 150 nm, and is more preferably 20 nm to 120 nm, and even more preferably 30 nm to 100 nm from a viewpoint of realization of high-density recording. The magnetic layer may be at least one layer, or the magnetic layer can be separated to two or more layers having magnetic properties, and a configuration regarding a well-known multilayered magnetic layer can be applied. A thickness of the magnetic layer which is separated into two or more layers is a total thickness of the layers.

A thickness of the non-magnetic layer is, for example, 0.1 to 1.5 μm and is preferably 0.1 to 1.0 μm.

A thickness of the back coating layer is preferably equal to or smaller than 0.9 μm and even more preferably 0.1 to 0.7 μm.

The thicknesses of various layers of the magnetic recording medium and the non-magnetic support can be acquired by a well-known film thickness measurement method. As an example, a cross section of the magnetic recording medium in a thickness direction is, for example, exposed by a well-known method of ion beams or microtome, and the exposed cross section is observed with a scanning electron microscope. In the cross section observation, various thicknesses can be acquired as a thickness acquired at one portion in a thickness direction, or an arithmetical mean of thicknesses acquired at a plurality of portions of two or more portions, for example, two portions which are randomly extracted. In addition, the thickness of each layer may be acquired as a designed thickness calculated according to the manufacturing conditions.

### Manufacturing Step

A step of preparing the composition for forming the magnetic layer, and the non-magnetic layer and the back coating layer which are randomly provided, include at least a kneading step, a dispersing step, or a mixing step provided before and after these steps, if necessary. Each step may be divided into two or more stages. All of raw materials used in the invention may be added at an initial stage or in a middle stage of each step. In addition, each raw material may be separately added in two or more steps. In order to prepare each layer forming composition, a well-known technology can be used. In the kneading step, an open kneader, a continuous kneader, a pressure kneader, or a kneader having a strong kneading force such as an extruder is preferably used. The details of the kneading processes of these kneaders are disclosed in JP1989-106338A (JP-H01-106338A) and JP1989-079274A (JP-H01-079274A). In addition, in order to disperse each layer forming composition, as a dispersion medium, at least one or more kinds of dispersion beads selected from the group consisting of glass beads and other dispersion beads can be used. As such dispersion beads, zirconia beads, titania beads, and steel beads which are dispersion beads having high specific gravity are suitable. These dispersion beads are preferably used by optimizing a particle diameter (bead diameter) and a filling percentage. As a disperser, a well-known disperser can be used. Each layer forming composition may be filtered by a well-known method before performing the coating step. The filtering can be performed by using a filter, for example. As the filter used in the filtering, a filter having a hole diameter of 0.01 to 3 μm (for example, filter made of glass fiber or filter made of polypropylene) can be used, for example.

The magnetic layer can be formed by directly applying the magnetic layer forming composition (the composition for a magnetic recording medium) onto the surface of the non-magnetic support or through a step of performing multilayer coating with the non-magnetic layer forming composition in order or at the same time. The back coating layer can be formed through a step of applying a back coating layer forming composition onto a surface of the non-magnetic support opposite to the surface provided with the magnetic layer (or to be provided with the magnetic layer).

After the coating step, various processes such as a drying process, an alignment process of the magnetic layer, and a surface smoothing treatment (calender process) can be performed. Regarding the coating step and various processes, a well-known technology can be used, and for example, a description disclosed in paragraphs 0051 to 0057 of JP2010-024113A can be referred to.

In any stage after the coating step of the magnetic layer forming composition, the heat treatment of a coating layer formed by applying the magnetic layer forming composition is preferably performed. This heat treatment can be performed before and/or after the calender process, for example. The heat treatment can be, for example, performed by placing a support, on which the coating layer of the magnetic layer forming composition is formed, in heated atmosphere. The heated atmosphere can be an atmosphere at an atmosphere temperature of 50° C. to 90° C., and more preferably an atmosphere at an atmosphere temperature of 50° C. to 80° C. This atmosphere can be, for example, the atmosphere. The heat treatment under the heated atmosphere can be, for example, performed for 12 to 72 hours, preferably 24 to 48 hours. By this heat treatment, the isocyanate group can be generated by blocking agent dissociated from the compound represented by General Formula 1, and the curing reaction of the isocyanate group can proceed. Meanwhile, examples of JP1992-003313A (JP-H4-003313A) discloses a block isocyanate compound in which an isocyanate group is protected by using an oxime compound as a blocking agent. For this block isocyanate compound, a heat treatment at a temperature of approximately 100° C. or a temperature higher than that is necessary for the dissociation of the blocking agent, and a catalyst is also necessary. Specifically, in the example of JP1992-003313A (JP-H4-003313A), the heat treatment at 100° C. is performed using dibutyltin dilaurate as the catalyst. In contrast, the curing agent for a magnetic recording medium according to one aspect of the invention described above can generate the isocyanate group by dissociating the blocking agent, by a heat treatment at a temperature lower than 100° C., for example, a heat treatment in an atmosphere with an atmosphere temperature of 50° C. to 90° C. In addition, the blocking agent can also be dissociated by such a heat treatment, without using a catalyst which catalyzes the reaction of dissociating the blocking agent. Therefore, in one aspect, the composition for a magnetic recording medium according to one aspect of the invention described above can be a composition not containing the catalyst which catalyzes the reaction of dissociating the blocking agent.

Through the step described above, a magnetic recording medium including a magnetic layer which is a cured layer obtained by curing the composition for a magnetic recording medium according to one aspect of the invention on a non-magnetic support. The cured layer is preferably a thermosetting layer (cured layer formed by proceeding the curing reaction by the heat treatment). In one aspect, the magnetic recording medium can be a tape-shaped magnetic recording medium (magnetic tape), and in another aspect, the magnetic recording medium can be a disk-shaped magnetic recording medium (magnetic disk).

### EXAMPLES

Hereinafter, the invention will be described in more detail with reference to examples. However, the invention is not limited to the aspect shown in the examples. A “part” shown below is a parts by mass, and various steps were performed in atmosphere at room temperature (atmosphere temperature of 20° C. to 25° C.), unless otherwise noted.

### Synthesis Example of Block Isocyanate Compound

A polyisocyanate compound, a blocking agent, and a solvent were introduced to a 200 mL three-neck flask in a nitrogen atmosphere. An inner temperature (liquid temperature) of this flask was heated to 40° C. and the materials were stirred for 2 hours. Except a synthesis example of a reaction product BL-2, a reaction solution was collected and analyzed by infrared spectroscopy (IR), and it was found that a peak of the isocyanate group is lost. Then, the inner temperature of the flask was cooled to room temperature, to obtain a reaction product (solution having a concentration of the reaction product of 50% by mass). The weight-average molecular weight of the obtained reaction product was obtained by the method described above, and a value shown in Table 1 was obtained.

Except the synthesis example of reaction product BL-2, it is possible to find that a block isocyanate compound having the following structure is generated from the used amount of the synthesis raw material and the weight-average molecular weight of the reaction product, in each synthesis example. In the synthesis example of the reaction product BL-2, the used amount of the polyisocyanate compound was decreased to be smaller than the amount used for obtaining a reaction product BL-1, and accordingly, the structure of the reaction product BL-2 can be shown as follows.

Regarding the reaction product including n in the following structure, it is thought that n=1, in a structure of a main component included in the reaction product.

In Table 1 shown below, “MEK” indicates methyl ethyl ketone and a mixing ratio of a mixed solvent is based on mass. In addition, all of the polyisocyanate compounds in Table 1 are commercially available products; CORONATE 3041 is manufactured by Tosoh Corporation, and the other polyisocyanate compounds are manufactured by Mitsui Chemicals, Inc. Each commercially available product is the following polyisocyanate compounds.

CORONATE 3041: Trimethyloipropane adduct of 2,4-tolylene diisocyanate

TAKENATE D-110N: Trimethylolpropane adduct of xylylene diisocyanate 2,4-tolylene diisocyanate

TAKENATE D-120N: Trimethylolpropane adduct of hydrogenated xylylene diisocyanate 2,4-tolylene diisocyanate

TAKENATE D-140N: Trimethylolpropane adduct of isophorone diisocyanate

TAKENATE D-160N: Trimethylolpropane adduct of hexamethylene diisocyanate

TAKENATE D-165N: Hexamethylene diisocyanate (HDI) biuret

TAKENATE D-170N: HDI isocyanurate

TAKENATE D-178N: HDI allophanate

TABLE 1

| Reaction | | | Polyisocyanate | | | | |
|---|---|---|---|---|---|---|---|
| product (block | | | compound | | | | |
| isocyanate | Blocking agent | | Kind | | Solvent | | Weight-average |
| compound) | | Amount | (product | Amount | | Amount | molecular |
| No. | Kind | (g) | name) | (g) | Kind | (g) | weight |
| BL-1 | 3,5-dimethylpyrazole | 8.87 | CORONATE | 40 | Mixed solvent of | 8.87 | 1,000 |
| | | | 3041 | | toluene/MEK at | | |
| | | | | | 1/1 | | |
| BL-2 | 3,5-dimethylpyrazole | 2.96 | CORONATE | 40 | Mixed solvent of | 2.96 | 800 |
| | | | 3041 | | toluene/MEK at | | |
| | | | | | 1/1 | | |
| BL-3 | 2-methylimidazole | 8.87 | CORONATE | 40 | Mixed solvent of | 8.87 | 900 |
| | | | 3041 | | toluene/MEK at | | |
| | | | | | 1/1 | | |
| BL-4 | Acetanilide | 12.47 | CORONATE | 40 | Mixed solvent of | 12.47 | 900 |
| | | | 3041 | | toluene/MEK at | | |
| | | | | | 1/1 | | |
| BL-5 | Stearic acid anilide | 33.18 | CORONATE | 40 | Mixed solvent of | 33.18 | 1,300 |
| | | | 3041 | | toluene/MEK at | | |
| | | | | | 1/1 | | |
| BL-6 | 3,5-dimethylpyrazole | 9.38 | TAKENATE | 30 | Ethyl acetate | 24.38 | 1,000 |
| | | | D-110N | | | | |
| BL-7 | 3,5-dimethylpyrazole | 9.14 | TAKENATE | 30 | Ethyl acetate | 24.14 | 1,000 |
| | | | D-120N | | | | |
| BL-8 | 3,5-dimethylpyrazole | 8.18 | TAKENATE | 30 | Ethyl acetate | 23.18 | 1,000 |
| | | | D-140N | | | | |
| BL-9 | 3,5-dimethylpyrazole | 12.16 | TAKENATE | 30 | Ethyl acetate | 27.16 | 1,000 |
| | | | D-160N | | | | |
| BL-10 | 3,5-dimethylpyrazole | 12.17 | TAKENATE | 20 | Ethyl acetate | 32.17 | 1,200 |
| | | | D-165N | | | | |
| BL-11 | 3,5-dimethylpyrazole | 11.54 | TAKENATE | 20 | Ethyl acetate | 31.54 | 1,200 |
| | | | D-170N | | | | |
| BL-12 | 3,5-dimethylpyrazole | 15.81 | TAKENATE | 20 | Ethyl acetate | 35.81 | 1,200 |
| | | | D-178N | | | | |
| BL-13 | Acetanilide | 17.11 | TAKENATE | 20 | Ethyl acetate | 37.11 | 1,200 |
| | | | D-165N | | | | |
| R-2 | 2-butanone oxime | 8.04 | CORONATE | 40 | Mixed solvent of | 8.04 | 900 |
| | | | 3041 | | toluene/MEK at | | |
| | | | | | 1/1 | | |

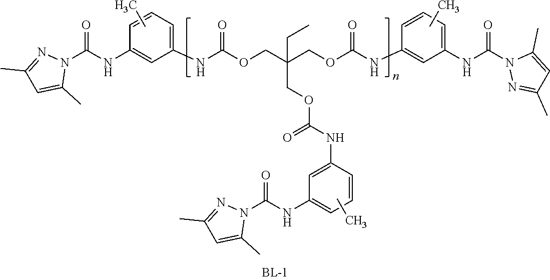

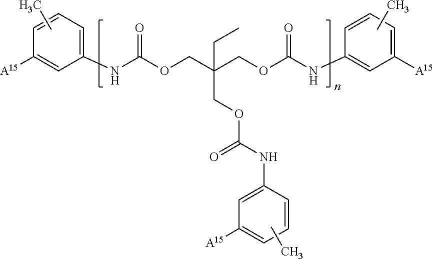

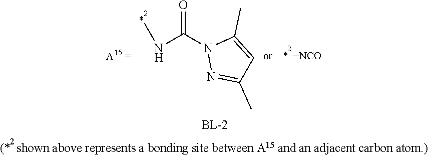

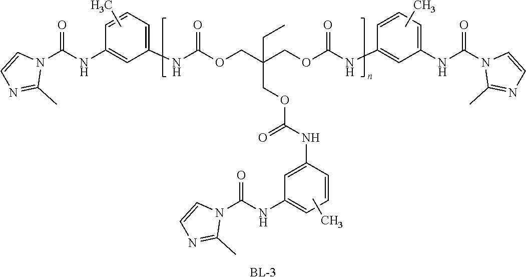

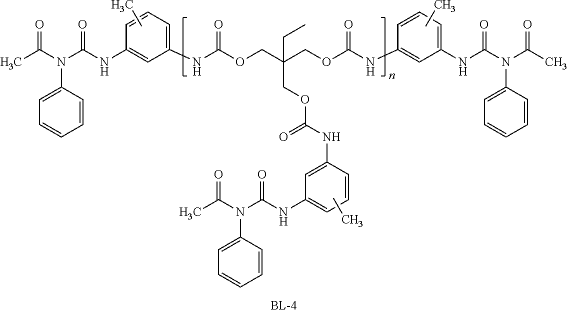

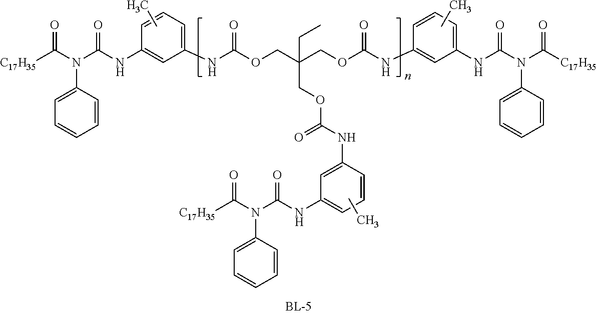

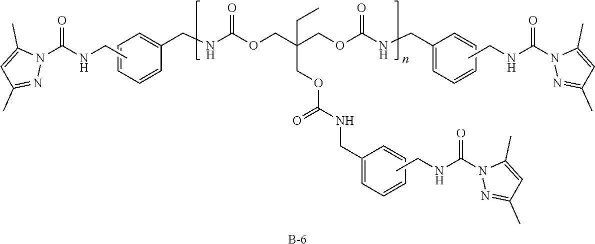

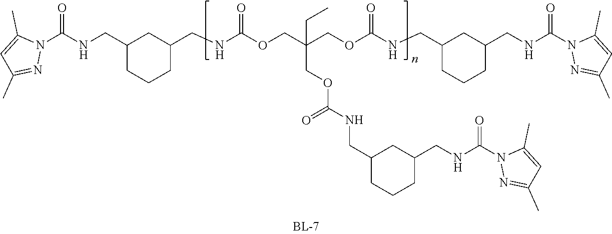

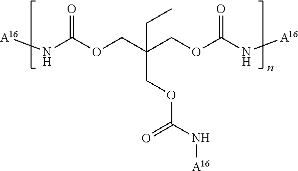

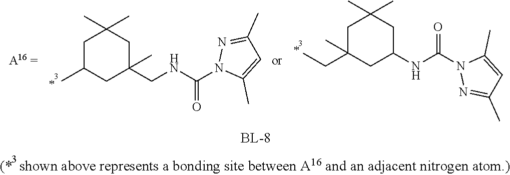

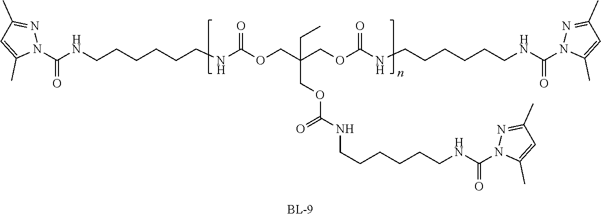

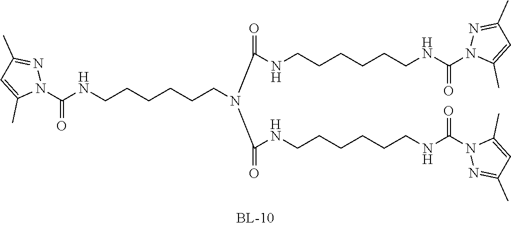 [SMILES: Cc1cc(C)n(C(=O)NCCCCCCNC(=O)N(CCCCCCNC(=O)n2nc(C)cc2C)C(=O)NCCCCCCNC(=O)n2nc(C)cc2C)n1]

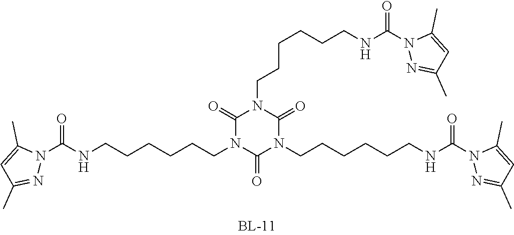 [SMILES: Cc1cc(C)n(C(=O)NCCCCCCn2c(=O)n(CCCCCCNC(=O)n3nc(C)cc3C)c(=O)n(CCCCCCNC(=O)n3nc(C)cc3C)c2=O)n1]

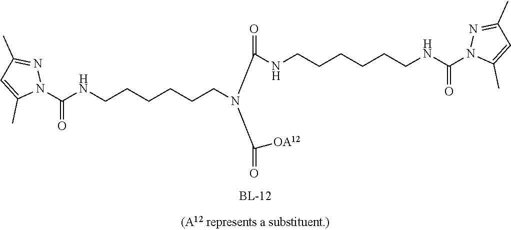

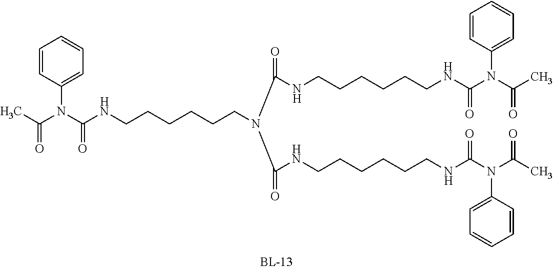 [SMILES: CC(=O)N(C(=O)NCCCCCCNC(=O)N(CCCCCCNC(=O)N(C(C)=O)c1ccccc1)C(=O)NCCCCCCNC(=O)N(C(C)=O)c1ccccc1)c1ccccc1]

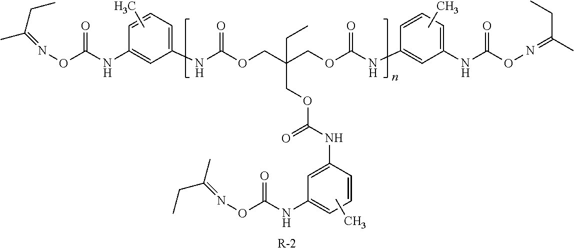

### Example 1

### (1) Preparation of Magnetic Layer Forming Composition (Composition for Magnetic Recording Medium)

The following components were kneaded with an open kneader, and dispersed using a sand mill to prepare a dispersion liquid.

Ferromagnetic hexagonal ferrite powder: 100.0 parts

Composition excluding oxygen (molar ratio): Ba/Fe/Co/Zn=1/9/0.2/1

Coercivity Hc: 160 kA/m (2000 Oe)

Average particle size (average plate diameter): 20 nm

Average plate ratio: 2.7

Brunauer-Emmett-Teller (BET) specific surface area: 60 m²/g

Saturation magnetization us: 46 A·m²/kg (46 emu/g)

Polyethyleneimine derivative J-1 disclosed in JP2015-028830A: 10.0 parts

Polyurethane resin (VYLON (registered trademark) UR4800 manufactured by Toyobo Co., Ltd., SO₃Na concentration: 70 eq/ton, weight-average molecular weight: 70,000, hydroxy group concentration: 4 to 6 mgKOH/g): 4.0 parts

Vinyl chloride resin (MR104 manufactured by manufactured by Kaneka Corporation, weight-average molecular weight: 55000, hydroxy group concentration: 0.33 meq/g): 10.0 parts

α-Al₂O₃ (average particle size: 0.1 μm): 8.0 parts

Carbon black (average particle size: 0.08 μm): 0.5 parts

Cyclohexanone: 600.0 parts

The following components were added to the obtained dispersion liquid and stirred, subjected to ultrasonic treatment, and filtered using a filter having a hole diameter of 1 μm, and a magnetic layer forming composition (composition for a magnetic recording medium) was obtained.

Butyl stearate: 1.5 parts

Stearic acid: 0.5 parts

Stearic acid amide: 0,2 parts

Methyl ethyl ketone: 50.0 parts

Cyclohexanone: 50.0 parts

Toluene: 3.0 parts

Block isocyanate compound: 2.5 parts (using 5.0 parts as the reaction product BL-1 (solution having a concentration of the reaction product of 50% by mass) obtained in the synthesis example)

### (2) Preparation of Non-Magnetic Layer Forming Composition

The components shown below were kneaded with an open kneader and dispersed using a sand mill, to obtain a dispersion liquid.

Carbon black: 100.0 parts

Dibutyl phthalate (DBP) oil absorption amount: 100 ml/100 g

pH: 8

BET specific surface area: 250 m²/g

Volatile content: 1.5% by mass

Polyurethane resin (VYLON UR4800 manufactured by Toyobo Co., Ltd., SO₃Na concentration: 70 eq/ton, weight-average molecular weight: 70,000): 20.0 parts

Vinyl chloride resin (OSO₃K concentration: 70 eq/ton): 30.0 parts

Trioctyl amine: 4.0 parts

Cyclohexanone: 140.0 parts

Methyl ethyl ketone: 170.0 parts

Butyl stearate: 2.0 parts

Stearic acid: 2.0 parts

Stearic acid amide: 0.1 parts

The following components were added to the obtained dispersion liquid and stirred, and filtered using a filter having a hole diameter of 1 μm, and a non-magnetic layer forming composition was prepared.

Butyl stearate: 1.5 parts

Stearic acid: 1.0 parts

Methyl ethyl ketone: 50.0 parts

Cyclohexanone: 50.0 parts

Toluene: 3.0 parts

Polyisocyanate compound (CORONATE 3041 manufactured by Tosoh Corporation): 5.0 parts

### (3) Preparation of Back Coating Layer Forming Composition

The components described above were preliminarily kneaded with a roll mill and dispersed using a sand mill. 4.0 parts of a polyester resin (VYLON 500 manufactured by Toyobo Co., Ltd.), 14.0 parts of a polyisocyanate compound (CORONATE 3041 manufactured by Tosoh Corporation), and 5.0 parts of α-Al₂O₃ (manufactured by Sumitomo Chemical Co., Ltd.) were added, stirred, and filtered, and a back coating layer forming composition was obtained.

Carbon black (average particle size of 40 nm): 85.0 parts

Carbon black (average particle size of 100 nm): 3.0 parts

Nitrocellulose: 28.0 parts

Polyurethane resin: 58.0 parts

Copper phthalocyanine-based dispersing agent: 2.5 parts

Polyurethane resin (NIPPOLAN 2301 manufactured by Tosoh Corporation): 0.5 parts

Methyl isobutyl ketone: 0.3 parts

Methyl ethyl ketone: 860.0 parts

Toluene: 240.0 parts

### (4) Manufacturing of Magnetic Tape

A corona discharge treatment was performed on both surfaces of a polyethylene naphthalate support having a thickness of 5.0 μm.

The non-magnetic layer forming composition was applied onto one surface of the polyethylene naphthalate support so that a thickness of the non-magnetic layer after the drying becomes 1.0 μm, and immediately after that, the magnetic layer forming composition was applied thereon at the same time so that a thickness of the magnetic layer after the drying becomes 100 nm. While both layers were in a wet state, a homeotropic alignment process was performed by cobalt magnet having a magnetic force of 0.5 T (5,000 G) and solenoid having a magnetic force of 0.4 T (4,000 G), and then, the drying process was performed. Then, the back coating layer forming composition was applied onto the other surface of the polyethylene naphthalate support so that a thickness of the back coating layer after the drying becomes 0.5 μm, and a calender process was performed with a seven-stage calender configured with a metal roll at a surface temperature of the calender roll of 100° C. at a rate of 80 m/min. After that, the heat treatment was performed in an atmosphere with an atmosphere temperature of 70° C. for 24 hours, the slitting was performed to have a width of ½ inches (0.0127 meters), and a magnetic tape was manufactured.

### Examples 2 to 13 and Comparative Example 2

A magnetic tape was manufactured by the same method as that in Example 1, except that 5.0 parts by mass of the reaction product shown in Table 2 was used, instead of the reaction product BL-1.

### Comparative Example 1

A magnetic tape was manufactured by the same method as that in Example 1, except that 5.0 parts by mass of a polyisocyanate compound R-1 (CORONATE 3041 is manufactured by Tosoh Corporation) was used, instead of the reaction product BL-1. A structure of the polyisocyanate compound R-1 (CORONATE 3041 is manufactured by Tosoh Corporation) is shown below.

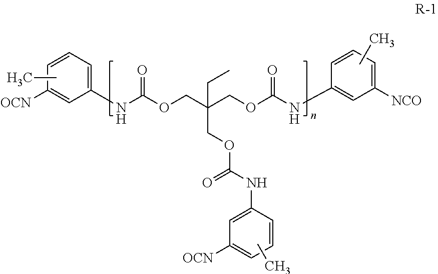

### Evaluation Method of Running Durability

The magnetic tape was transferred to an edge of a prismatic column bar made of Al₂O₃/TiC having a cross section having a size of 7 mm×7 mm so as to come into contact with a surface of a magnetic layer at an angle of 150 degrees, and a portion of the magnetic tape having a length of 100 m was slid one pass under the conditions of a load of 100 g and a speed of 6 m per second. The edge of the prismatic column bar after sliding was observed with an optical microscope, and an attached state of attachments (chips of the surface of the magnetic layer chipped due to the sliding) was evaluated. The evaluation was set as a functional evaluation and evaluation was performed in 10 stages. In a case of 10, the amount of chips are the smallest, in a case of 1, the amount of chips are greatest. In a case where the evaluation result is 5 or larger, it can be determined that a magnetic tape having excellent running durability, with few attachments is obtained.

In a case where the curing reaction of the isocyanate group proceeds in an excellent manner in the formation of the magnetic layer, smoothness of the surface of the magnetic layer tends to increase. An increase in smoothness of the surface of the magnetic layer contributes to the improvement of electromagnetic conversion characteristics. Therefore, regarding each magnetic tape of the examples and the comparative examples, the evaluation of the electromagnetic conversion characteristics was performed by the following method.

### Electromagnetic Conversion Characteristics: evaluation method of Signal-To-Noise Ratio (SNR Ratio)

Signals having a linear recording density of 172 kfci and 86 kfci was recorded and reproduced using a linear-tape-open (LTO)-Generation 4 (Gen4) drive by setting a recording track width f 11.5 μm and a reproduction track width of 5.3 μm. The reproduced signal was frequency-analyzed with a spectrum analyzer, and a ratio of output of a carrier signal in a case of reproducing a signal recorded at a linear recording density of 172 kfci, and integral noise in all spectra band in a case of reproducing a signal recorded at a linear recording density of 86 kfci was set as an SNR ratio. An LTO-Gen 4 tape manufactured by Fujifilm Corporation was used as a reference tape. The SNR of Comparative Example 1 was set as 0 dB, and the SNR of each magnetic tape was obtained as a relative value. The unit kfci is a unit of a linear recording density (not convertible into SI unit).

TABLE 2

| | | Running | |
|---|---|---|---|
| | | durability | |
| | Reaction product ^{Note)} | Evaluation | SNR |
| | (block isocyanate compound) No. | result | (dB) |
| Example 1 | BL-1 | 10 | 1.5 |
| Example 2 | BL-2 | 7 | 1.2 |
| Example 3 | BL-3 | 8 | 1.3 |
| Example 4 | BL-4 | 8 | 1.3 |
| Example 5 | BL-5 | 7 | 1.2 |
| Example 6 | BL-6 | 8 | 1.3 |
| Example 7 | BL-7 | 7 | 1.2 |
| Example 8 | BL-8 | 10 | 1.5 |
| Example 9 | BL-9 | 8 | 1.2 |
| Example 10 | BL-10 | 7 | 1.2 |
| Example 11 | BL-11 | 7 | 1.2 |
| Example 12 | BL-12 | 6 | 1.0 |
| Example 13 | BL-13 | 5 | 0.8 |
| Comparative | R-1 | 4 | 0 |
| Example 1 | | | |
| Comparative | R-2 | 1 | −1.2 |
| Example 2 | | | |

^{Note)}
polyisocyanate compound in Comparative Example 1

The inventors have thought that a reason for that the running durability and the electromagnetic conversion characteristics are deteriorated in Comparative Example 1, in which the magnetic layer was formed using the polyisocyanate compound not protected by the blocking agent, compared to the examples, as shown in Table 2, is due to occurrence of deactivation of the polyisocyanate compound.

In addition, from the results shown in Table 2, in Examples 1 to 13, the evaluation results of the running durability and electromagnetic conversion characteristics were excellent, compared to Comparative Example 2 in which the magnetic layer is formed using the block isocyanate using the oxime compound as the blocking agent. It is thought that this shows that the block isocyanate compound used in the formation of the magnetic layer in Examples 1 to 13 causes the dissociation of the blocking agent by the heat treatment (atmosphere temperature of 70° C.) during the formation of the magnetic layer, and the excellent proceeding of the curing reaction (formation of the crosslinked structure) of the isocyanate group generated by the dissociation.

The invention is effective in a technical field of various magnetic recording media such as magnetic tapes for data storage.

What is claimed is:

1. A curing agent,
which is a curing agent for a magnetic recording medium and comprises a compound represented by General Formula 1; 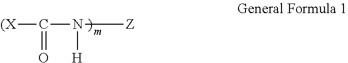
in General Formula 1, X represents a monovalent heterocyclic group or a monovalent group represented by General Formula 2, Z represents an m-valent organic group, and m represents an integer of 2 or more; 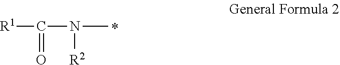
in General Formula 2, R¹ represents an alkyl group, R² represents a hydrogen atom, an alkyl group, or an aryl group, and represents a bonding site with an adjacent carbon atom.

2. The curing agent according to claim 1,
wherein, in General Formula 1, m represents an integer of 2 to 8.

3. The curing agent according to claim 1,
wherein, in General Formula 1, X represents a monovalent nitrogen-containing heterocyclic group.

4. A composition,
which is a composition for a magnetic recording medium and comprises:
a ferromagnetic powder;
a binding agent; and
the curing agent according to claim 1.

5. The composition according to claim 4,
wherein the binding agent includes a binding agent including an active hydrogen-containing group.

6. The composition according to claim 5,
wherein the active hydrogen-containing group is a hydroxy group.

7. The composition according to claim 4,
wherein an average particle size of the ferromagnetic powder is 10 nm to 50 nm.

8. The composition according to claim 4,
wherein ferromagnetic powder is a ferromagnetic hexagonal ferrite powder.

9. The composition according to claim 4,
wherein, in General Formula 1, m represents an integer of 2 to 8.

10. The composition according to claim 4,
wherein, in General Formula 1, X represents a monovalent nitrogen-containing heterocyclic group.

11. A magnetic recording medium comprising:
a non-magnetic support; and
a magnetic layer provided on the non-magnetic support,
wherein the magnetic layer is a cured layer obtained by curing the composition according to claim 4.

12. The magnetic recording medium according to claim 11,
wherein the binding agent includes a binding agent including an active hydrogen-containing group.

13. The magnetic recording medium according to claim 12,
wherein the active hydrogen-containing group is a hydroxy group.

14. The magnetic recording medium according to claim 11,
wherein an average particle size of the ferromagnetic powder is 10 nm to 50 nm.

15. The magnetic recording medium according to claim 11,
wherein ferromagnetic powder is a ferromagnetic hexagonal ferrite powder.

16. The magnetic recording medium according to claim 11,
wherein, in General Formula 1, m represents an integer of 2 to 8.

17. The magnetic recording medium according to claim 11,
wherein, in General Formula 1, X represents a monovalent nitrogen-containing heterocyclic group.

18. A manufacturing method of a magnetic recording medium including a non-magnetic support, and a magnetic layer provided on the non-magnetic support, the method comprising:
forming the magnetic layer on the non-magnetic support,
in which the forming of the magnetic layer includes
applying the composition for a magnetic recording medium according to claim 4 on the non-magnetic support to form a coating layer, and
performing a heat treatment with respect to the coating layer.

19. The manufacturing method of a magnetic recording medium according to claim 18,
wherein the heat treatment is performed in an atmosphere with an atmosphere temperature of 50° C. to 90° C.
